(19) United States
(12) Patent Application Publication
(10) Pub. No.: US 2025/0287926 A1
(43) Pub. Date: Sep. 18, 2025

(54) FEEDBACK DEVICE, REARING SYSTEM, FEEDBACK METHOD, AND PROGRAM

(71) Applicant: SEIKO EPSON CORPORATION, TOKYO (JP)

(72) Inventors: Takumi SUZUKI, MATSUMOTO-SHI (JP); Ryoki WATANABE, Matsumoto-shi (JP); Hikaru KURASAWA, Matsumoto-shi (JP); Kenji MATSUZAKA, SHIOJIRI-SHI (JP)

(21) Appl. No.: 19/078,531

(22) Filed: Mar. 13, 2025

(30) Foreign Application Priority Data
Mar. 14, 2024 (JP) 2024-039787

(51) Int. Cl. A01K 29/00; G06V 40/10

(52) U.S. Cl. CPC A01K 29/005; G06V 40/10

(57) ABSTRACT

A feedback device includes a first acquisition unit configured to acquire first information including current information indicating a current rearing state of a cow, a second acquisition unit configured to acquire second information including at least one of future information indicating a future rearing state of the cow and an ideal condition indicating a condition ideal for rearing of the cow, and a feedback execution unit configured to execute feedback relating to the rearing to at least one of a user and a rearing device for rearing the cow. The feedback execution unit includes a generation unit configured to generate feedback information for the feedback by using the first information and the second information, and an output unit configured to output the feedback information.

The present application is based on, and claims priority from JP Application Serial Number 2024-039787, filed Mar. 14, 2024, the disclosure of which is hereby incorporated by reference herein in its entirety.

### BACKGROUND

### 1. Technical Field

The present disclosure relates to a feedback device, a rearing system, a feedback method, and a program.

### 2. Related Art

JP-A-2007-175050 discloses a management system that automatically estimates a weight of an individual animal based on image information relating to the individual animal, which is acquired by an imaging means, and a distance to the individual animal, and guides and sorts the individual animal to a predetermined feeding area by comparing the estimated weight and an evaluation standard weight.

In recent years, the importance of individual livestock management and the importance of production planning management have been increasing in the livestock industry. For example, in recent years, the number of livestock farmers has been decreasing year by year due to high labor demands and an aging workforce, and there has been a push toward large-scale production to maintain production levels. Under such circumstances, it is desirable to implement individual management so as to mitigate an increased load in a working environment associated with individual managing for large-scale production and prevent any adverse impacts on animal welfare. Further, for example, cows are resilient to the cold but struggle with the heat, which tends to result in milk production shortages in the summer and surpluses in the winter. Consequently, surplus milk is often discarded during the winter. Thus, it is desirable to manage production planning to balance demand with production levels. In order to achieve proper individual management and production planning management, there is a need for technologies that provide appropriate feedback in livestock rearing.

### SUMMARY

According to a first mode of the present disclosure, a feedback device is provided. The feedback device includes a first acquisition unit configured to acquire first information including current information indicating a current rearing state of a cow, a second acquisition unit configured to acquire second information including at least one of future information indicating a future rearing state of the cow and an ideal condition indicating a condition ideal for rearing of the cow, and a feedback execution unit configured to execute feedback relating to the rearing to at least one of a user and a rearing device for rearing the cow. The feedback execution unit includes a generation unit configured to generate feedback information for the feedback by using the first information and the second information, and an output unit configured to output the feedback information.

According to a second mode of the present disclosure, a rearing system for rearing a cow is provided. The rearing system includes a rearing device for rearing the cow, a first acquisition unit configured to acquire first information including current information indicating a current rearing state of the cow, a second acquisition unit configured to acquire second information including at least one of future information indicating a future rearing state of the cow and an ideal condition indicating a condition ideal for rearing of the cow, and a feedback execution unit configured to execute feedback relating to the rearing to at least one of a user and the rearing device. The feedback execution unit includes a generation unit configured to generate feedback information for the feedback by using the first information and the second information, and an output unit configured to output the feedback information.

According to a third mode of the present disclosure, a feedback method is provided. The feedback method includes acquiring first information including current information indicating a current rearing state of a cow, acquiring second information including at least one of future information indicating a future rearing state of the cow and an ideal condition indicating a condition ideal for rearing of the cow, and executing feedback relating to the rearing to at least one of a user and a rearing device for rearing the cow. The feedback includes generating feedback information for the feedback by using the first information and the second information, and outputting the feedback information.

According to a fourth mode of the present disclosure, a program is provided. The program causes a computer to implement a function of acquiring first information including current information indicating a current rearing state of a cow, a function of acquiring second information including at least one of future information indicating a future rearing state of the cow and an ideal condition indicating a condition ideal for rearing of the cow, and a feedback function of executing feedback relating to the rearing to at least one of a user and a rearing device for rearing the cow. The feedback function includes a generation function of generating feedback information for the feedback by using the first information and the second information, and an output function of outputting the feedback information.

### BRIEF DESCRIPTION OF THE DRAWINGS

FIG. 1 is an explanatory view illustrating a schematic configuration of a rearing system.

FIG. 2 is a block diagram illustrating a schematic configuration of a feedback device.

FIG. 3A is a first diagram illustrating an example of first information, second information, and feedback information.

FIG. 3B is a second diagram illustrating an example of the first information, the second information, and the feedback information.

FIG. 4 is a flowchart of a feedback process.

FIG. 5 is a flowchart of an acquisition process.

FIG. 6 is a flowchart of a feedback execution process.

FIG. 7 is a flowchart of a model update process.

FIG. 8 is a flowchart of a first learning process.

FIG. 9 is a flowchart of a second learning process.

### DESCRIPTION OF EMBODIMENTS

### A. First Embodiment

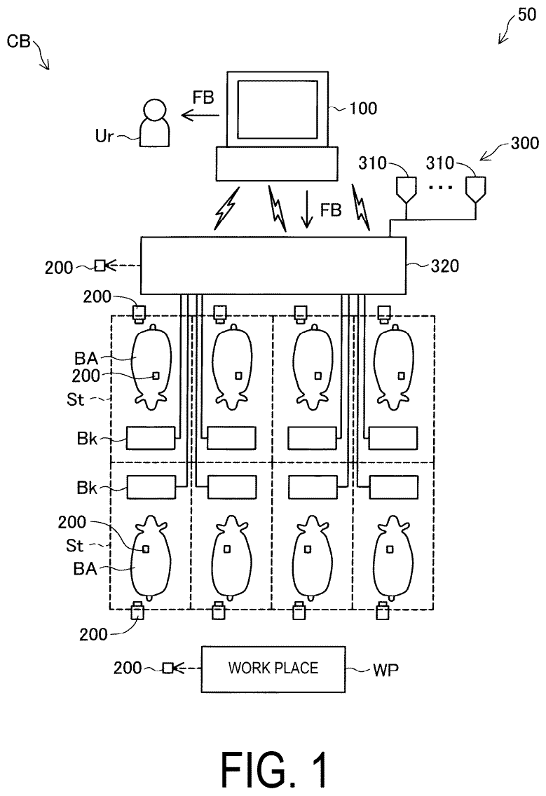

FIG. 1 is an explanatory view illustrating a schematic configuration of a rearing system 50 of a first embodiment. The rearing system 50 is configured as a system for rearing a cow BA as livestock. In the embodiment, the cow BA is a milk cow. In another embodiment, for example, the cow BA may be a beef cow.

In the embodiment, the rearing system 50 is used in a cowshed CB. The cowshed CB includes a plurality of stalls St for accommodating the cows BA and one or more work places WP. In the embodiment, one cow BA is allocated to one stall St. In each of the stalls St, a feed trough Bk for containing feed is installed. The feed in the feed troughs Bk is fed to the cow BA. The work place WP is a place for performing various tasks relating to rearing of the cow BA. For example, the work place WP of the embodiment includes a measurement place for performing measurement on the cow BA, a disposal place for disposing excrement of the cow BA, a milking place for milking the cow BA, and a preparation place for preparing feed. Note that, for example, at least a part of the stall St may be used as a work place.

The rearing system 50 includes a feedback device 100 and one or more rearing devices 300. Further, the rearing system 50 of the embodiment includes one or more sensors 200.

The rearing device 300 is a device for rearing the cow BA. The rearing device 300 of the embodiment is configured as a feeding device that feeds the cow BA. The rearing device 300 includes a plurality of charging units 310 with which ingredients of a feed mixture are charged and a blending unit 320 that blends the ingredients being charged. For example, the charging unit 310 is configured by a hopper. For example, the blending unit 320 is configured by a mixer that mixes and blends the ingredients. In the rearing device 300, the respective ingredients charged into the charging units 310 are blended by the blending unit 320 to prepare a feed mixture, and the feed mixture being prepared is supplied to the feed trough Bk. Note that the ingredients may be prepared feed or commercially available feed, for example. In another embodiment, for example, the rearing device 300 may be configured to execute only one of preparation of the feed and provision of the feed to the cow BA. Further, for example, the feeding device may be configured as a feeding robot. For example, the feeding robot executes preparation and provision of the feed.

The sensor 200 is a sensor for monitoring the cow BA. For example, the sensor 200 includes a sensor for acquiring a state of the cow BA and a sensor for acquiring a rearing environment of the cow BA. Further, for example, the sensor 200 includes a camera, a weight scale, a motion sensor, a microphone, a temperature sensor, a humidity sensor, a photoelectric sensor, a spectrometer, an illuminance meter, an anemometer, and an anemoscope. For example, the sensor 200 may be installed at each point in the cowshed CB, or may be attached to the cow BA. For example, the camera is installed at the stall St, in the rearing device 300, in the vicinity of the rearing device 300, or at the work place WP. For example, the camera captures an image of the cow BA, the feed, milk of the cow BA, or excrement of the cow BA. For example, the camera may be a stereo camera. For example, the weight scale is installed at the work place WP, and measures a weight of the cow BA, a weight of milk, or a weight of excrement. For example, the motion sensor includes an acceleration sensor and an angular velocity sensor. For example, the motion sensor is attached to each of the cows BA. For example, the temperature sensor includes a thermometer for measuring a body temperature of the cow BA and a thermometer for measuring an environmental temperature in the cowshed CB. For example, the temperature sensor may be configured by an infrared camera. For example, the temperature sensor is installed to the cow BA or at each point in the cowshed CB. For example, the photoelectric sensor is configured by an infrared sensor that detects presence or absence of an object through transmission and reception of infrared light. The spectrometer is used to analyze various targets such as feed, milk, and excrement by using an optical spectrum. For example, the spectrometer may be configured as a spectroscopic camera.

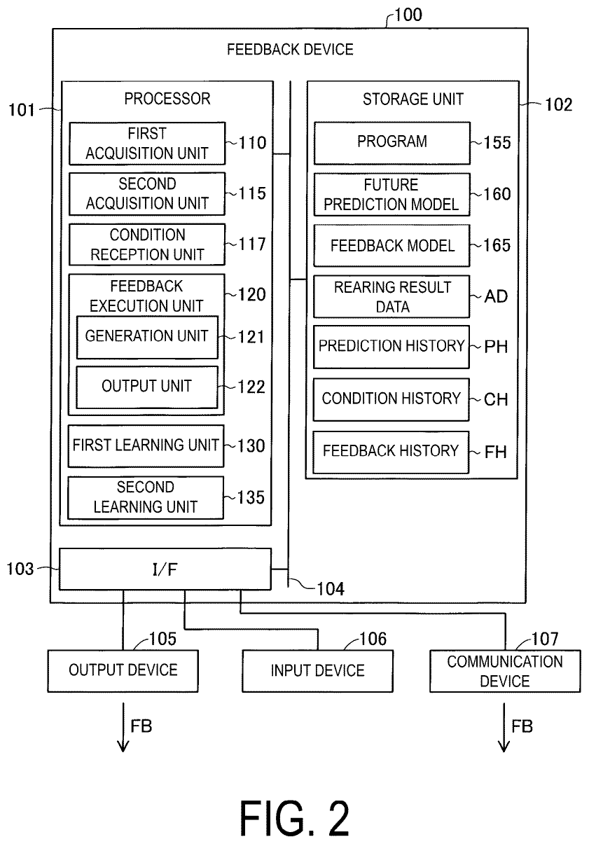

FIG. 2 is a block diagram illustrating a schematic configuration of the feedback device 100 of the first embodiment. The feedback device 100 of the embodiment is configured by a computer including one or more processors 101, a storage unit 102 including a ROM and a RAM, an input/output interface 103, and an internal bus 104. The processor 101, the storage unit 102, and the input/output interface 103 are coupled to each other in a mutually communicable manner via the internal bus 104. An output device 105, an input device 106, and a communication device 107 are connected to the input/output interface 103. The storage unit 102 of the embodiment stores a program 155, a future prediction model 160, a feedback model 165, rearing result data AD, a prediction history PH, a feedback history FH, and a condition history CH. The processor 101 executes the program 155 stored in the storage unit 102 to implement various functions including functions as a first acquisition unit 110, a second acquisition unit 115, a condition reception unit 117, a feedback execution unit 120, a first learning unit 130, and a second learning unit 135.

For example, the input device 106 is configured by a mouse or a keyboard. The feedback device 100 receives various inputs from a user Ur via the input device 106.

The output device 105 is configured as a display device capable of outputting visual information, a speaker capable of outputting audio information, or a printing device capable of outputting information by performing printing on a medium. For example, the display device is configured by a liquid crystal panel or an organic EL panel. Note that, for example, the output device 105 being a display device may be configured as a touch panel capable of receiving a touch operation from the user Ur. In this case, for example, the output device 105 may also function as the input device 106.

The communication device 107 is a device for communicating a device outside of the feedback device 100 through wireless communication or wired communication. The communication device 107 of the embodiment is configured to communicate with each of the sensors 200 and the rearing devices 300.

The output device 105 and the communication device 107 may be configured to output various information stored in the storage unit 102, such as the rearing result data AD, the prediction history PH, the feedback history FH, and the condition history CH, in response to a request from the user Ur.

The first acquisition unit 110 acquires first information. The first information includes current information. The current information indicates a current rearing state of the cow BA. The rearing state indicates at least one of the state of the cow BA and the rearing environment of the cow BA. Details of the current information are described later.

In the embodiment, the first acquisition unit 110 acquires the first information by using the detection result from the sensor 200. Specifically, the first acquisition unit 110 acquires at least part of the current information included in the first information by using the detection result from the sensor 200. For example, the first acquisition unit 110 acquires the detection result from the sensor 200 as the current information. In this case, for example, the current information may be so-called raw data acquired by the sensor 200 or data obtained by subjecting raw data to a process such as a statistical process and a correction process as appropriate. Further, for example, the first acquisition unit 110 acquires information stored in advance in the storage unit 102 as the current information. Specifically, the first acquisition unit 110 acquires result information included in the rearing result data AD as the current information. The rearing result data AD is data obtained by recording information indicating at least the most recent rearing state. For example, the rearing result data AD includes the detection result from the sensor 200, information that is acquired as the current information in the past, and information that is input to the feedback device 100 by the user Ur. Further, the first acquisition unit 110 acquires the current information by using various estimation models for estimating the current information, which are omitted in illustration. For example, the estimation model is a machine learning model that is trained to acquire the current information while using the detection result from the sensor 200 as an input. For example, a neural network, a support vector machine (SVM), a decision tree, a random forest, a linear regression analysis, linear discrimination, reinforcement learning, and a stochastic model may be used for the machine learning model. The machine learning model) may be a deep learning model such as a convolutional neural network (CNN). Further, for example, the machine learning model may be trained by using various algorithms such as supervised learning, unsupervised learning, and reinforcement learning.

The second acquisition unit 115 acquires second information. The second information includes at least one of future information and an ideal condition. The second information of the embodiment includes the future information and the ideal condition. The future information indicates a future rearing state of the cow BA. The ideal condition indicates a condition ideal for rearing the cow BA. Details of the future information and the ideal condition are described later.

In the embodiment, the second acquisition unit 115 acquires the second information by using the future prediction model 160. Specifically, the second acquisition unit 115 acquires at least part of the future information included in the second information by using the future prediction model 160. The future prediction model 160 is a machine learning model that is trained to output the future information while using the current information as an input. In other words, the future prediction model 160 is a model for predicting the future rearing state. Substantially similarly to the estimation model described above, various machine learning models may be used as the future prediction model 160.

Further, in the embodiment, the second acquisition unit 115 acquires the ideal condition by using the current information. Specifically, the second acquisition unit 115 refers to ideal condition data CD, based on the current information and the future information. With this, at least part of the ideal condition included in the second information is acquired. The ideal condition data CD is data obtained by recording a condition that is determined in advance as the ideal condition.

Prior to acquisition of the ideal condition, the condition reception unit 117 receives at least one of setting of an item used as the ideal condition and setting of a level of the ideal condition from the user Ur. The setting of the item and the level is executed via the input device 106, for example. In the embodiment, the second acquisition unit 115 acquires a condition corresponding to an item received by the condition reception unit 117, as the ideal condition. Details of “the setting of the level of the ideal condition” are described later.

The feedback execution unit 120 executes feedback relating to rearing of the cow BA to at least one of the user Ur and the rearing device 300 that are illustrated in FIG. 1. Hereinafter, the feedback relating to rearing of the cow BA is also referred to as rearing feedback FB.

As illustrated in FIG. 2, the feedback execution unit 120 includes a generation unit 121 and an output unit 122. The generation unit 121 generates feedback information by using the first information and the second information. The feedback information is information for the rearing feedback FB. The generation unit 121 of the embodiment generates the feedback information by using the current information that is included in the first information and the future information and the ideal condition that are included in the second information. The output unit 122 outputs the feedback information being output from the generation unit 121.

The generation unit 121 of the embodiment generates the feedback information by using the feedback model 165. The feedback model 165 is a machine learning model that is trained to output the feedback information while using the first information and the second information as inputs. Substantially similarly to the estimation model described above, various machine learning models may be used as the feedback model 165.

The first learning unit 130 executes a first learning process for training the future prediction model 160. The second learning unit 135 executes a second learning process for training the feedback model 165. In the first learning process of the embodiment, supervised learning is executed. Further, in the second learning process of the embodiment, reinforcement learning is executed. Details of the first learning process and the second learning process are described later.

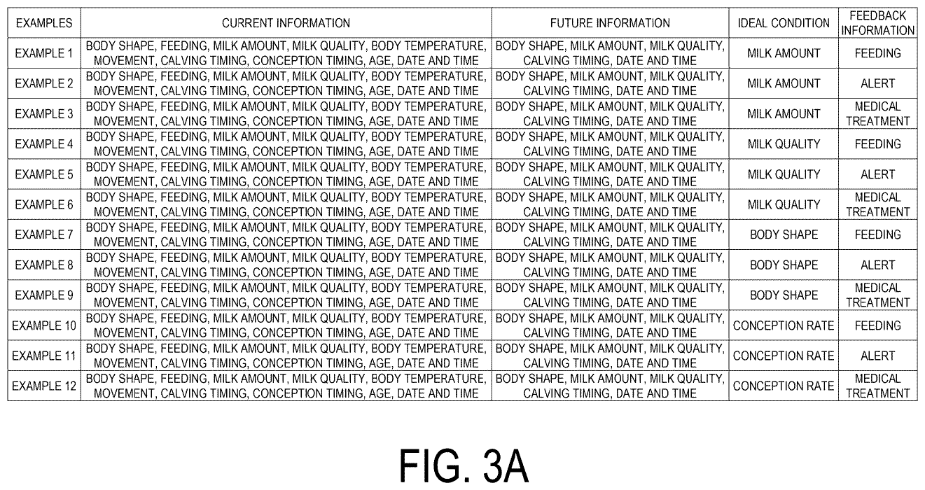

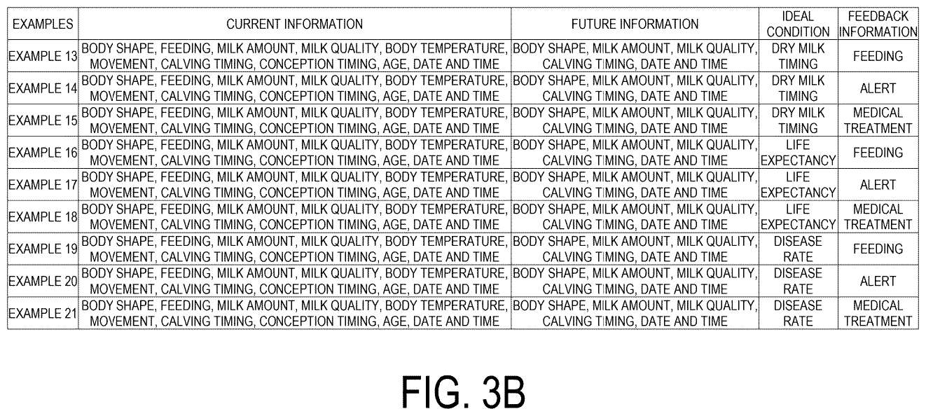

FIG. 3A is a first diagram illustrating an example of the first information, the second information, and the feedback information. FIG. 3B is a second diagram illustrating an example of the first information, the second information, and the feedback information. FIG. 3A and FIG. 3B show Example 1 to Example 21. Each of the examples shown in FIG. 3A and FIG. 3B is an example of a combination of the first information, the second information, and the feedback information.

As shown in FIG. 3A and FIG. 3B, in the embodiment, the first information includes at least any one of body shape information, feeding information, milk information, body temperature information, motion information, calving timing information, conception timing information, and age information, as the current information. The body shape information, the milk information, the motion information, the calving timing information, the conception timing information, and the age information correspond to information indicating the state of the cow BA. The feeding information corresponds to information indicating the rearing environment of the cow BA. Further, the first information further includes first date and time information. For example, the first date and time information is date and time information indicating at least one of date and time when each information piece included in the first information and date and time when each information piece is acquired.

The body shape information is information relating to a body shape of the cow BA. For example, the body shape information includes at least any one of a weight of the cow BA, a height of the cow BA, a body condition score (BCS) of the cow BA. In the embodiment, the first acquisition unit 110 acquires the body shape information by using the sensor 200. Specifically, for example, the first acquisition unit 110 acquires a value measured by the weight scale as the weight of the cow BA. Further, for example, the first acquisition unit 110 acquires the height of the camera and the BCS. For example, the first acquisition unit 110 may acquire the height and the BCS by using various estimation models, which are omitted in illustration. For example, the estimation model for estimating the BCS is a machine learning model that is trained to output the BCS of the cow BA while using a captured image of the cow BA by the camera as an input.

The feeding information is information relating to feeding of the cow BA. For example, the feeding information includes at least any one of feed amount information relating to a feed amount, feed formulation information relating to feed formulation, component information relating to a component contained in the feed, and feeding timing information relating to feeding timing of the cow BA. For example, the feed amount information is expressed by a weight or a volume of the feed. For example, feed the feed formulation information is expressed as a blending ratio of each ingredient in a feed mixture. Specifically, for example, the feed formulation information is expressed by a blending ratio of a concentrated feed and a roughage feed. For example, the component information is expressed by an amount of a ratio of a component contained in the feed. For example, the feeding timing information is expressed by date or time. For example, the first acquisition unit 110 acquires the feed amount information by using the camera and the weight scale, and acquires the feed formulation information and the component information by using the camera and the spectrometer. For example, the first acquisition unit 110 may acquire the feed amount information, the feed formulation information, and the component information by using an estimation model. In this case, for example, as the estimation model, a machine learning model that is trained to output the feed amount information, the feed formulation information, and the component information while using a captured image and an optical spectrum as inputs may be used. For example, the feed amount information, the feed formulation information, and the component information may be input by the user Ur via the input device 106. The first acquisition unit 110 may acquire the feed amount information, the feed formulation information, and the component information that are input by the user Ur. For example, the first acquisition unit 110 may acquire, from the storage unit 102, the feed amount information, the feed formulation information, and the component information that are recorded as the rearing result data AD. Further, for example, the first acquisition unit 110 acquires, as the feeding timing information, date and time of the most recent feeding that are stored as the rearing result data AD in the storage unit 102. Note that, for example, the feeding timing information may be recorded in the storage unit 102, based on an input by the user Ur, or may be recorded in the storage unit 102, based on the result obtained by detecting the feeding by the sensor 200.

The milk information is information relating to milk of the cow BA. The milk information includes at least any one of milk amount information and milk quality information. The milk amount information is information relating to an amount of milk. The milk quality information is information relating to quality of milk. For example, the milk amount information is expressed by a weight or a volume of milk produced by the cow BA per predetermined reference time. For example, the reference time is one month, one week, one day, one minute, or one second. For example, the milk quality information is expressed by a ratio of a component contained in milk. For example, the first acquisition unit 110 acquires the milk amount information by using the camera and the weight scale, and acquires the milk quality information by using the camera and the spectrometer. For example, the first acquisition unit 110 may acquire the milk amount information and the milk quality information by using the estimation model. In this case, for example, as the estimation model, a machine learning model that is trained to output the milk amount information and the milk quality information while using a captured image and an optical spectrum as inputs may be used.

The body temperature information is information relating to a body temperature of the cow BA. For example, the first acquisition unit 110 acquires the body temperature information by using the temperature sensor.

The motion information is information relating to movement of the cow BA. For example, the motion information includes a moving speed of the cow BA, acceleration, presence or absence of predetermined movement of the cow BA, a locomotion score of the cow BA, the number of times and a duration of the predetermined movement per predetermined reference time. For example, the predetermined movement includes traveling, stopping, excreting, and escaping from the cowshed CB or the stall St. For example, the first acquisition unit 110 acquires the motion information by using the camera and the motion sensor. For example, the first acquisition unit 110 may acquire the motion information by using the estimation model. In this case, for example, as the estimation model, a machine learning model that is trained to output presence or absence, the number of times, and a duration of the predetermined movement while using a captured image and a sensor value from the motion sensor as inputs may be used. Further, for example, the estimation model may be a machine learning model that is trained to output a locomotion score while using a captured image and a sensor vale from the motion sensor as inputs.

The calving timing information is information relating to a calving timing of the cow BA. For example, the calving timing information is expressed by date and time of the most recent calving of the cow BA. The conception timing information is information relating to a conception timing of the cow BA. For example, the conception timing information is expressed by date and time of the most recent conception of the cow BA. The age information is information relating to an age of the cow BA. For example, as the calving timing information, the conception timing information, and the age information, the first acquisition unit 110 acquires various types of information recorded as the rearing result data AD in the storage unit 102. Specifically, for example, the first acquisition unit 110 acquires the recent calving date and time, the recent conception date and time, and the current age that are recorded as the rearing result data AD. Note that, for example, the calving timing information, the conception timing information, and the age information may be recorded in the storage unit 102, based on an input by the user Ur. Further, the calving timing information and the conception timing information may be recorded in the storage unit 102, based on a result of detecting calving or conception by the sensor 200.

The future information of the embodiment includes at least any one of future body shape information, future milk information, and expected calving timing information. The future body shape information is information relating to a future body shape of the cow BA. The future milk information is information relating to future milk of the cow BA. The future milk information includes at least any one of future milk amount information and future milk quality information. The future milk amount information is information relating to a future milk amount. The future milk quality information is information relating to future milk quality. The expected calving timing information is information relating to an expected calving timing of the cow BA. The future body shape information, the future milk information, and the expected calving timing information are substantially similar to the body shape information, the milk information, and the calving timing information, respectively, except that each piece of the information is information indicating a future rearing state. Further, in the embodiment, the future information further includes second date and time information. For example, the second date and time information is date and time information for indicating date and time of a rearing state indicated by each piece of the information included in the future information.

As described above, in the embodiment, the future information is acquired by using the future prediction model 160. For example, the future prediction model 160 may be commonly shared for each piece of the information included in the future information. Specifically, for example, the future prediction model 160 may be a machine learning model that outputs the future body shape information, the future milk information, and the expected calving timing information while using the current information as an input. Further, for example, the future prediction model 160 may be prepared individually for one or a plurality of pieces of information included in the future information. In this case, for example, each future prediction model 160 may be a machine learning model that outputs any one or two of the future body shape information, the future milk information, and the expected calving timing information while using at least part of the current information as an input.

Note that, when the future prediction model 160 outputs certain information included in the future information, the current information corresponding to the certain information may be used as at least part of an input to the future prediction model 160. For example, when the future prediction model 160 outputs the future body shape information, the body shape information may be used as an input. Further, when the future prediction model 160 outputs the future milk information, the milk information may be used as an input. Further, when the future prediction model 160 outputs the expected calving timing information, the calving timing information may be used as an input. In this manner, the future rearing state can be predicated at higher accuracy by using the future prediction model 160, and
the future information can be acquired more appropriately.

The ideal condition of the embodiment includes at least any one of the milk condition, a body shape condition, a conception rate condition, a dry milk timing condition, a life expectancy condition, and a disease rate condition. The milk condition is a condition relating to ideal milk of the cow BA. The milk condition includes at least any one of a milk amount condition and a milk quality condition. The milk amount condition is a condition relating to an ideal milk amount of the cow BA. The milk quality condition is a condition relating to an ideal milk quality of the cow BA. The body shape condition is a condition relating to an ideal body shape of the cow BA. The conception rate condition is a condition relating to an ideal conception rate. The dry milk timing condition is a condition relating to an ideal dry milk timing. For example, the dry milk timing condition is expressed as an ideal dry milk starting date. The life expectancy condition is a condition relating to ideal life expectancy. The disease rate condition is a condition relating to an ideal disease rate.

For example, the second acquisition unit 115 acquires the milk condition by referring to the ideal condition data CD, based on at least one of the calving timing information and the body shape information. In this case, at least one of the calving timing information and the body shape information, and the milk condition may be associated with each other and stored in the ideal condition data CD. Further, for example, the second acquisition unit 115 acquires the body shape condition by referring to the ideal condition data CD, based on at least one of the age information and the expected calving timing information. In this case, at least one of the age information and the expected calving timing information, and the body shape condition may be associated with each other and stored in the ideal condition data CD. Further, for example, the second acquisition unit 115 acquires the dry milk timing condition by referring to the ideal condition data CD, based on at least one of the milk information and the calving timing information. In this case, at least one of the milk information and the calving timing information, and the dry milk timing condition are associated with each other and stored in the ideal condition data CD. Further, similarly to the milk condition and the like described above, for example, the second acquisition unit 115 may acquire the conception rate condition, the life expectancy condition, and the disease rate condition by referring to the ideal condition data CD, based on one or a plurality of pieces of the current information. Note that, for example, the second acquisition unit 115 may acquire the ideal condition from an external computer, a recording medium, or the like.

Note that, for example, each condition included as the ideal condition may be set from the perspective of mitigating an increased load in a working environment in the cowshed CB while maintaining a satisfactory health state of the cow BA and maintaining high levels of milk production efficiency and quality. For example, the life expectancy in the life expectancy condition may be set to be long enough to maintain a satisfactory health state of the cow BA and to be short enough to maintain high levels of milk production efficiency and quality and mitigate an increased load in a working environment in the cowshed CB. Further, the disease rate in the disease rate condition may be set to be low enough to maintain a satisfactory health state of the cow BA and to be high enough to maintain high levels of milk production efficiency and quality and mitigate an increased load in a working environment in the cowshed CB.

For example, “the setting of the level of the ideal condition” by the condition reception unit 117, which is described above, includes at least any one of setting of a numerical value of the ideal condition and setting of a weight of the ideal condition. When the setting of the numerical value of the ideal condition is received, the second acquisition unit 115 acquires the received numerical value as the ideal condition. The weight of the ideal condition indicates a weight by which the ideal condition is reflected in the feedback information. For example, a higher conception rate is generally preferable. Thus, in some cases, as the conception rate condition, a conception rate is set to a rate that is too high to be practically achieved. Further, for example, a lower disease rate is generally preferable. Thus, in some cases, as the disease rate condition, a disease rate is set to a rate that is too low to be practically achieved. Even when such an ideal condition that cannot be practically achieved is set, the possibility of appropriately generating the feedback information can be increased by receiving the weight setting.

The feedback information of the embodiment includes at least any one of feeding feedback information, medical treatment feedback information, and alert information.

The feeding feedback information is information for the feedback relating to feeding. For example, the feeding feedback information includes information for performing feedback relating to the feed amount, the blending ratio of each ingredient in the feed, the feeding timing, and the feeding frequency. In the embodiment, the feedback information is transmitted to the rearing device 300 being a feeding device via the communication device 107. The feedback information to the rearing device 300 as described above may include a control instruction for controlling the rearing device 300. The rearing device 300 that receives the feeding feedback information executes feeding to the cow BA in accordance with the amount, the blending ratio, and the feeding frequency that are included in the feedback information. For example, when the feedback information including an instruction for increasing the feed amount is received, the rearing device 300 increases the feeding frequency or the feed amount given per feeding in accordance with the feedback information. Note that, for example, the feedback information may be output to the user Ur via the output device 105, in addition to or instead of being output to the rearing device 300. For example, when the feeding feedback information is output to the user Ur, the user Ur can adjust the feed amount, the blending ratio of the feed, the feeding timing, and the feeding frequency in accordance with the feeding feedback information.

The alert information is information for issuing an alert to the user Ur. The medical treatment feedback information is information for the feedback relating to medical treatment for the cow BA. For example, the medical treatment includes a check-up, medication, exercise, and rest.

As shown in FIG. 3A and FIG. 3B, the current information and the future information are the same in the respective examples from Example 1 to Example 21. Meanwhile, the ideal conditions are the milk amount condition, the milk quality condition, the body shape condition, the conception rate condition, the dry milk timing condition, the life expectancy condition, and the disease rate condition, respectively, in Example 1 to Example 3, Example 4 to Example 6, Example 7 to Example 9, Example 10 to Example 12, Example 13 to Example 15, Example 16 to Example 18, and Example 19 to Example 21. Further, the feedback information in Example 1, Example 4, Example 7, Example 10, Example 13, Example 16, and Example 19 is the feeding feedback information. Further, the feedback information in Example 2, Example 5, Example 8, Example 11, Example 14, Example 17, and Example 20 is the alert information. Further, the feedback information in Example 3, Example 6, Example 9, Example 12, Example 15, Example 18, and Example 21 is the medical treatment feedback information.

In the following description, unless otherwise noted, it is assumed that a combination of the current information, the future information, the ideal condition, and the feedback information corresponds to a combination in Example 1.

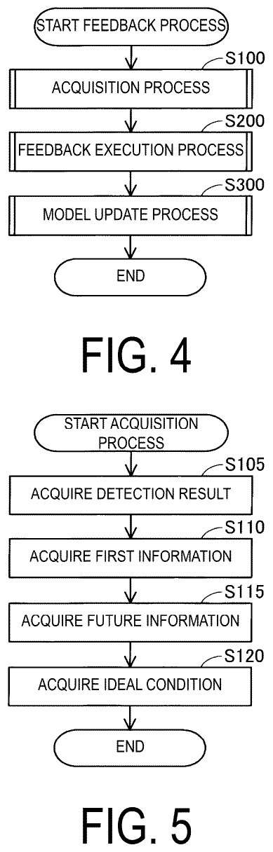

FIG. 4 is a flowchart of a feedback process for executing the feedback method of the embodiment. For example, the feedback process is started by the processor 101 at a predetermined time interval. As illustrated in FIG. 4, the feedback process in the embodiment includes an acquisition process in Step S100, a feedback execution process in Step S200, and a model update process in Step S300. The feedback execution process is also referred to as a feedback step. Further, a function of executing the feedback execution process is also referred to as a feedback function.

FIG. 5 is a flowchart of the acquisition process executed in Step S100 in FIG. 4. In Step S105 in FIG. 5, the first acquisition unit 110 acquires the detection result from the sensor 200. In Step S110, the first acquisition unit 110 acquires the first information included in the current information. In Step S110, as described above, at least part of the information included as the current information in the first information is acquired by using the detection result acquired in Step S105. Note that the respective pieces of the information acquired in Step S105 and Step S110 are recorded as the rearing result data AD in the storage unit 102.

In Step S115, the second acquisition unit 115 acquires the future information. Specifically, the second acquisition unit 115 acquires the future information by inputting the detection result acquired in Step S105 or the first information to the future prediction model 160. Note that the future information acquired in Step S115 is recorded as the prediction history PH in the storage unit 102.

In Step S120, the second acquisition unit 115 acquires the ideal condition. Specifically, as described above, in Step S120, the second acquisition unit 115 acquires at least part of the conditions included as the ideal condition by referring to the ideal condition data CD, based on the current information and the future information. Note that the ideal condition acquired in Step S120 is recorded as the condition history CH in the storage unit 102. In the embodiment, Step S115 and Step S120 are executed as described above. With this, the second information including the future information and the ideal condition is acquired.

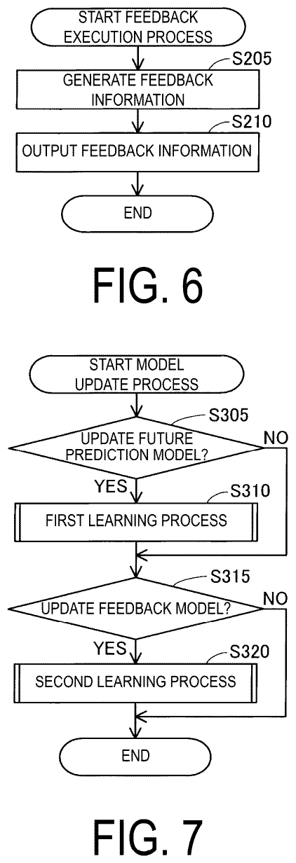

FIG. 6 is a flowchart of the feedback execution process executed in Step S200 in FIG. 4. In Step S205 in FIG. 6, the generation unit 121 generates the feedback information by using the first information acquired in Step S105 in FIG. 5, the future information acquired in Step S210, and the ideal condition acquired in Step S215. Specifically, the generation unit 121 generates the feedback information by inputting the first information, the future information, and the ideal condition to the feedback model 165. Note that the feedback information generated in Step S205 is recorded as the feedback history FH in the storage unit 102. In Step S210, the output unit 122 outputs the feedback information generated in Step S205. Specifically, in Step S210 in the embodiment, the output unit 122 transmits the feeding feedback information to the rearing device 300, and outputs the medical treatment feedback information and the alert information to the user Ur via the output device 105.

FIG. 7 is a flowchart of the model update process executed in Step S300 in FIG. 4. In Step S305, the first learning unit 130 determines whether to execute the first learning process. In the embodiment, when a first standard is satisfied, the first learning unit 130 determines to execute the first learning process. For example, the first standard indicates that the number of data pieces stored as the rearing result data AD in the storage unit 102 is equal to or more than a predetermined threshold value, a difference level between the future information that is previously predicated and the current information is equal to or more than a predetermined threshold value, or a difference between the ideal condition and the current information is equal to or more than a predetermined threshold value. When it is determined to execute the first learning process in Step S305, the first learning unit 130 executes the first learning process in Step S310.

In Step S325, the second learning unit 135 determines whether to execute the second learning process. In the embodiment, when a second standard is satisfied, the second learning unit 135 determines to execute the second learning process. For example, the second standard indicates that the number of times of the rearing feedback FB executed during a predetermined period is equal to or more than a predetermined threshold value, a difference level between the future information that is previously predicated and the current information is equal to or more than a predetermined threshold value, or a difference between the ideal condition and the current information is equal to or more than a predetermined threshold value. For example, the number of times of the rearing feedback FB may be determined based on the number of data pieces of the feedback information that is recorded as the feedback history FH in the storage unit 102. When it is determined to execute the second learning process in Step S315, the second learning unit 135 executes the second learning process in Step S320.

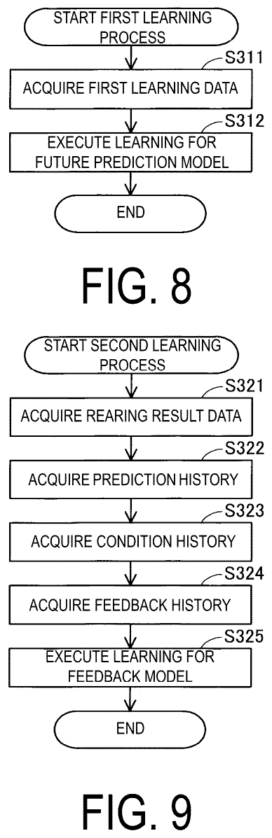

FIG. 8 is a flowchart of the first learning process. In Step S311, the first learning unit 130 acquires first learning data. The first learning data is used to train the future prediction model 160. The first learning data includes a plurality of pieces of labeled data. The labeled data included in the first learning data is first data to which second data is provided as a correct label. The first data indicates the rearing environment that is previously acquired as the current information. The second data indicates the rearing environment that is acquired as the current information after a predetermined period from the rearing environment indicated by the first data. In other words, the second data indicates the rearing environment in the future rearing environment for the rearing environment indicated by the first data. For example, when the predetermined period is one week, the first learning unit 130 can train the future prediction model 160 so that the rearing environment after one week can be suitably predicted. In this case, for example, the first learning unit 130 associates the first data and the second data with each other from the rearing result data AD, based on the time information of the current information recorded in the rearing result data AD. In this manner, the first learning data may be generated.

In Step S312, the first learning unit 130 executes learning for the future prediction model 160. Specifically, in Step S312 in the embodiment, the first learning unit 130 trains the future prediction model 160 by executing supervised learning that uses the first learning data acquired in Step S311. The first learning unit 130 stores, in the storage unit 102, the future prediction model 160 that is trained in Step S312. Herein, the first learning unit 130 may write the future prediction model 160 trained in Step S312 over the future prediction model 160 that is previously generated. Alternatively, the future prediction model 160 that is newly generated may be stored in the storage unit 102 while holding the previous future prediction model 160. In this manner, for example, as the future prediction model 160 specialized for the cowshed CB, the new future prediction model 160 may be used for the rearing feedback FB regarding the cowshed CB. At the same time, as the future prediction model 160 that is more versatile, the previous future prediction model 160 may be used for rearing feedback regarding other cowsheds. For example, the previous future prediction model 160 may be transmitted to various networks, other rearing systems, or other feedback devices via the communication device 107. Further, for example, the previous future prediction model 160 may be used to train other future prediction models.

Note that, in Step S312, for example, the first learning unit 130 may generate the new future prediction model 160 different from the future prediction model 160 that is previously generated. Further, in Step S312, the first learning unit 130 may execute additional learning for the future prediction model 160 that is previously generated. For example, transfer learning and fine-tuning may be used as methods of the additional learning.

FIG. 9 is a flowchart of the second learning process. In Step S321, the second learning unit 135 acquires at least part of the rearing result data AD from the storage unit 102. In Step S322, the second learning unit 135 acquires at least part of the prediction history PH from the storage unit 102. In Step S323, the second learning unit 135 acquires at least part of the condition history CH from the storage unit 102. In Step S324, the second learning unit 135 acquires at least part of the feedback history FH from the storage unit 102. Specifically, in Step S321 to Step S324, for example, the second learning unit 135 acquires the rearing result data AD, the prediction history PH, the condition history CH, and the feedback history FH from the current time point to a time point going back for a predetermined period.

In Step S324, the second learning unit 135 executes learning for the feedback model 165. Substantially similarly to the first learning unit 130, the second learning unit 135 may write the feedback model 165 trained in Step S324 over the feedback model 165 that is previously generated. Alternatively, the feedback model 165 that is newly generated may be stored in the storage unit 102 while holding the previous feedback model 165. Further, for example, the previous feedback model 165 may be transmitted to various networks, other rearing systems, or other feedback devices via the communication device 107. Further, for example, the previous feedback model 165 may be used to train other feedback models. Further, substantially similarly to the first learning unit 130, in Step S324, the second learning unit 135 may newly generate the feedback model 165, or may execute additional learning for the feedback model 165 that is previously generated.

In Step S324 in the embodiment, the second learning unit 135 executes reinforcement learning. Reinforcement learning is a method of learning an optimal solution that maximizes a total reward by iteratively repeating a trial-and-error cycle in which a training target is caused to perform a predetermined action in response to an environment state and then is given a reward for the action in a predetermined environment where the training target exists. For example, Q-learning is used as an algorithm for reinforcement learning. Q-learning is a method for learning a function Q (s, a) that expresses a value of an action when an action a is selected in a state s, where the state s of the environment and the action a that may be selected in the state s by the training target are independent variables. The optimal solution is to select the action a that maximizes the value function Q in the state s. Q-learning is started while the correlation between the state s and the action a is unknown, and a trial-and-error of selecting various actions a in freely-selected states s is repeated. In this manner, the value function Q is iteratively updated to approach the optimal solution.

In the second learning process in the embodiment, the function Q is defined as a function indicating a magnitude of a condition difference being a difference between an ideal condition at a certain point and an actual rearing condition after a predetermined period. Further, each of the current information included in the rearing result data AD acquired in Step S321 and the future information included in the prediction history PH acquired in Step S322 is used as the state s. Further, the feedback information included in the feedback history FH acquired in Step S323 corresponds to the action a. In Step S205 in FIG. 6, the first information, the future information, and the ideal condition are input to the feedback model 165 thus trained. Then, based on the first information, the future information, and the ideal condition that are input, the feedback information is output so that the difference between the ideal condition and the actual rearing condition is reduced after the predetermined period. Specifically, for example, the feedback information of the embodiment is information for adjusting the feed amount, the blending ratio of the feed, the feeding timing, and the feeding frequency so that a difference between an ideal milk amount and an actual milk amount is reduced.

It may be configured that the first learning process and the second learning process that are described above are executed at timing different from that in the process procedure of the update process. In this manner, for example, the future prediction model 160 and the feedback model 165 can be updated at timing desired by the user Ur. Further, in addition to a case in which the future prediction model 160 and the feedback model 165 are updated, when the future prediction model 160 and the feedback model 165 are newly generated, the first learning process and the second learning process can also be used. Further, in another embodiment, the update process may be omitted.

According to the feedback device 100 of the embodiment described above, the feedback information for the rearing feedback FB is generated and output by using the first information including the current information and the second information including the future information and the ideal condition. In this manner, the rearing feedback FB can be executed appropriately by using the feedback information in which the current information, the future information, and the ideal condition are reflected.

Further, in the embodiment, the first information is acquired by using the detection result from the sensor 200. In this manner, the detection result by the sensor can be reflected in the first information, and the detection result can be reflected in the feedback information.

Further, in the embodiment, the ideal condition included in the second information is acquired by using the current information. In this manner, the ideal condition corresponding to the current rearing state can be acquired. Thus, for example, as compared to a mode in which a constant ideal condition is acquired regardless of the current information, a more appropriate ideal condition can be acquired.

Further, in the embodiment, the current information includes at least any one of the body shape information, the feeding information, the milk information, the body temperature information, the motion information, the calving timing information, the conception timing information, and the age information. The ideal condition includes at least any one of the milk condition, the body shape condition, the conception rate condition, the dry milk timing condition, the life expectancy condition, and the disease rate condition. In this manner, it is possible to generate the feedback information in which the body shape information, the feeding information, the milk information, the body temperature information, the motion information, the calving timing information, the conception timing information, and the age information are reflected as the current information and the milk condition, the body shape condition, the conception rate condition, the dry milk timing condition, the life expectancy condition, and the disease rate condition are reflected.

Further, in the embodiment, the future information is acquired by using the future prediction model 160, and the first learning unit 130 that executes learning for the future prediction model 160 is provided. In this manner, the future information can be acquired by using the future prediction model 160 that is generated or updated by learning executing by the first learning unit 130, and the possibility of generating more appropriate feedback information can be increased.

Further, in the embodiment, the future information includes at least any one of the future body shape information, the future milk information, and the expected calving timing information. Therefore, the feedback information in which the future body shape, the future milk state, and the expected calving timing are reflected can be generated.

Further, in the embodiment, the feedback information is acquired by using the feedback model 165, and the second learning unit 135 that executes learning for the feedback model 165 is provided. In this manner, the feedback information can be generated by using the feedback model 165 that is generated or updated by learning executed by the second learning unit 135, and the possibility of generating more appropriate feedback information can be increased.

Further, in the embodiment, the feedback information includes the feeding information. Thus, appropriate feeding can be achieved by the user Ur or the rearing device 300 that receives the rearing feedback FB.

### B. Other Embodiments

(B-1) The feedback information may include various information for the rearing feedback FB in place of or in addition to the feeding feedback information.

For example, as shown in Example 2, Example 5, Example 8, Example 11, Example 14, Example 17, and Example 20 in FIG. 3A and FIG. 3B, the feedback information may include the alert information for issuing an alert to the user Ur. For example, an alert to the user Ur may be issued by using the output device 105, may be issued by using a computer different from the feedback device 100, or may be issued by using an alert device configured as a lamp or a buzzer. When an alert is issued by using the output device 105 or the computer, the alert information may include information for inputting an alert message for the alert to the output device 105, for example. For example, the alert message may include the feeding feedback information or the medical treatment feedback information. In this manner, the feedback information includes the alert information, and thus the user Ur that receives an alert can perform appropriate treatment for improving the rearing environment. Further, for example, when a difference between the ideal condition and the actual rearing environment is less than a threshold value, the generation unit 121 may generate the feeding feedback information or the medical treatment feedback information. When the difference is equal to or more than the threshold value, the generation unit 121 may generate the alert information. In this case, for example, the feedback model 165 may be trained to generate the feedback information in such a manner.

Further, as shown in Example 3, Example 6, Example 9, Example 12, Example 15, Example 18, Example 21 in FIG. 3A and FIG. 3B, the feedback information may include the medical treatment feedback information relating to medical treatment for the cow BA. For example, the medical treatment is executed by a veterinarian or a medical treatment device. The medical treatment device is a rearing device for executing the medical treatment. For example, the medical treatment feedback information may be output to the user Ur via the output device 105, or may be output to the medical treatment device via the communication device 107. For example, the medical treatment feedback information includes information for performing feedback relating to the necessity of a veterinarian, the intensity of medical treatment, the execution timing of medical treatment, and the execution frequency of medical treatment. For example, the information for performing feedback relating to the necessity of a veterinarian may be a message to encourage the user Ur to contact a veterinarian. Example of the intensity of medical treatment include frequency of check-ups, dosage, frequency of medication, exercise intensity, frequency of exercise, length of time resting, and frequency of resting. In this manner, the feedback information includes the medical treatment information, and thus appropriate medical treatment can be achieved by the user Ur or the rearing device 300 that receives the rearing feedback FB.

(B-2) The ideal condition may include various conditions in place of or in addition to the milk amount condition. For example, as shown in Example 4 to Example 6, Example 7 to Example 9, Example 10 to Example 12, Example 13 to Example 15, Example 16 to Example 18, and Example 19 to Example 21 in FIG. 3A and FIG. 3B, the ideal condition is not limited to the milk amount condition, and may include the milk quality condition, the body shape condition, the conception rate condition, the dry milk timing condition, the life expectancy condition, and the disease rate condition, for example. Further, for example, the ideal condition may include a condition regarding an ideal energy amount provided to the cow BA or a condition regarding an ideal feed cost. For example, the feed cost is expressed as a feed cost per milk amount.

(B-3) The future information may include only part of the future body shape information, the future milk information, and the expected calving timing information. Further, the future information may include various types of information indicating the future rearing state in place of or in addition to the information described above. For example, the future information may include future temperature information and future humidity information. The future temperature information is information relating to a future temperature in the cowshed CB. The future humidity information is information relating to future humidity in the cowshed CB. The future temperature information and the future humidity information correspond to information indicating the rearing environment of the cow BA. The future information includes the future temperature information and the future humidity information. Thus, for example, it is possible to generate the feedback information in which the fact that the cowshed CB is in a high-temperature and humid environment after a predetermined period is reflected. Specifically, for example, the feedback information in this case is feedback information for instructing treatment that further improves basic physical strength of the cow BA.

(B-4) The current information may include only part of the body shape information, the feeding information, the milk information, the body temperature information, the motion information, the calving timing information, the conception timing information, and the age information. Further, the current information may include various types of information indicating the current rearing state in place of or in addition to the information described above.

For example, the current information may include excrement information. The excrement information is information relating to excrement of the cow BA. The excrement information corresponds to information indicating the state of the cow BA. For example, the excrement information includes a component of excrement and an amount of excrement per standard hour. For example, the first acquisition unit 110 acquires the excrement information by using the camera, the weight scale, or the spectrometer as the sensor 200. For example, the first acquisition unit 110 may acquire the excrement information by using the estimation model.

(B-5) The ideal condition may include a condition that does not correspond to the current information. For example, as shown in Example 10 to Example 21 in FIG. 3A and FIG. 3B, the ideal condition may include the conception rate condition, the dry milk timing condition, the life expectancy condition, and the disease rate condition. In this manner, even when the first information does not include information relating to a conception rate, dry milk timing, life expectancy, or disease rate, the possibility of generating the feedback information that achieves an ideal conception rate, dry milk timing, life expectancy, or disease rate can be increased.

Further, for example, the current information may not include the milk information, and the ideal condition may include the milk condition. In this case, the current information may include at least any one of the body shape information, the feeding information, the body temperature information, the motion information, the calving timing information, the conception timing information, and the age information. In this manner, even when the first information does not include the milk information, the possibility of generating the feedback information that achieves ideal milk quality can be increased. Further, the current information may not include the body shape information, and the ideal condition ma include the body shape condition. In this case, the current information may include at least any one of the feeding information, the milk information, the body temperature information, the motion information, the calving timing information, the conception timing information, and the age information. In this manner, even when the first information does not include the body shape information, the possibility of generating the feedback information that achieves an ideal body shape can be increased.

(B-6) The rearing device 300 may include an air-conditioning device for performing air-conditioning in the cowshed CB in place of or in addition to the feeding device or the medical treatment device. For example, the air-conditioning device is configured as a device of cooling the cowshed CB, a device of warming the cowshed CB, or a device of humidifying the cowshed CB. For example, the air-conditioning device may include an opening/closing device that opens and closes a window provided to the cowshed CB. In this case, the feedback information to the rearing device may be information for performing feedback relating to air conditioning by an air-conditioning device. Specifically, for example, the feedback information may include a control instruction for causing the rearing device being an opening/closing device to automatically open or close the window.

(B-7) As described above, the future prediction model 160 and the feedback model 165 may be configured as various machine learning models, and may be trained by various learning methods. For example, the feedback model 165 may be trained by supervised learning. In this case, second learning data for training the feedback model 165 may include third data and fourth data being a correct label provided to the third data. The third data is information that is previously acquired as the current information and information that is previously acquired corresponding to the current information. The third data is prepared based on the rearing result data AD and the prediction history PH. The fourth data is information that is generated as the feedback information corresponding to the current information and the future information that are included in the third data. The fourth data is prepared based on the feedback history FH. Note that, for example, the second learning data may be generated by extracting a more effective rearing feedback result from the feedback history FH. The more effective rearing feedback result indicates that such feedback information that the difference between the ideal condition and the actual rearing condition is less than the predetermined value is generated. For example, extraction of such a feedback result may be based on the difference between the ideal condition and the actual rearing condition by the processor 101 without a manual operation by the user Ur, or may be executed manually by the user Ur.

(B-8) In the embodiment described above, the first information is acquired by using the detection result from the sensor 200. In contrast, the first information may be acquired without using the detection result, in other words, without using the sensor 200. In this case, for example, information may be input as the first information manually by the user Ur to the feedback device 100, and may be stored in the storage unit 102.

(B-9) In the embodiment described above, the second information includes the future information and the ideal condition. In contrast, the second information may include only any one of the future information and the ideal condition. When the second information does not include the future information, the future prediction model 160 may not be prepared. Further, in this case, for example, the feedback model 165 may be trained by using the current information and the ideal information without the future information. Further, for example, when the second information does not include the ideal condition, the feedback model 165 may be trained by using the current information and the future information without the ideal condition.

(B-10) In the embodiment described above, the ideal condition included in the second information is acquired by using the current information. However, the embodiment is not limited thereto. For example, a constant ideal condition may be acquired regardless of the current information without using the current information.

(B-11) The future prediction model 160 and the feedback model 165 may be prepared for each freely-selected unit. For example, the future prediction model 160 and the feedback model 165 may be prepared for each cow BA reared in the cowshed CB. In this manner, characteristics of each cow BA are easily reflected in the future information and the feedback information. Further, for example, the future prediction model 160 and the feedback model 165 may be prepared for each cowshed CB. In this manner, characteristics of each cowshed CB are easily reflected in the future information and the feedback information. Further, for example, the future prediction model 160 and the feedback model 165 may be prepared commonly for a plurality of cowsheds CB. For example, when the rearing system 50 manages the plurality of cowsheds CB, the future prediction model 160 and the feedback model 165 may be prepared commonly for the cowsheds CB managed by the rearing system 50. In this manner, general characteristics of the cows BA and the cowsheds CB are easily reflected in the future information and the feedback information.

Further, for example, a unit for which the future prediction model 160 or the feedback model 165 is prepared may differ for each piece of information included in the future information and the feedback information. In this manner, for example, characteristics of each cow BA or each cowshed CB and general characteristics of the cows BA and the cowsheds CB can be reflected appropriately in the future information and the feedback information. For example, the future prediction model 160 may be prepared for each cow BA by using the body shape information and the milk information that are acquired for each cow BA. Further, the feedback model 165 may be prepared for each cow BA by using such current information and future information that relate to each cow BA. In this manner, the body shape information, the milk information, and the like are information that are acquired daily, and hence the sufficient number of data pieces can be secured. Thus, the future prediction model 160 and the feedback model 165 can be prepared more appropriately. Further, for example, the future prediction model 160 may be prepared for each cowshed CB or commonly for the plurality of cowsheds CB by using the calving timing information and the conception timing information that are acquired for each cowshed CB or commonly for the plurality of cowsheds CB. Further, the feedback model 165 may be prepared for each cowshed CB or commonly for the plurality of cowsheds CB by using such current information and future information that are specific to each cowshed CB or are common to the plurality of cowsheds CB. In this manner, when the calving timing information, the conception timing information, and the like are acquired for each cow BA, the number of data pieces tends to be insufficient. Thus, the future prediction model 160 and the feedback model 165 can be prepared more appropriately. Further, for example, the future prediction model 160 and the feedback model 165 that are once prepared commonly for the plurality of cowsheds CB may be subjected to fine tuning for each cowshed CB or each cow BA afterward.

(B-12) In the embodiment described above, the feedback device 100 includes the first learning unit 130. In contrast, the feedback device 100 may not include the first learning unit 130. In this case, for example, learning for the future prediction model 160 may be executed by other devices included in the rearing system 50 or a device in a rearing system different from the rearing system 50. Substantially similarly, the feedback device 100 may not include the second learning unit 135.

(B-13) In the embodiment described above, the future information included in the second information is acquired by using the future prediction model 160. However, the embodiment is not limited thereto. For example, the future information may be acquired in a rule-based manner.

(B-14) In the embodiment described above, the feedback information is generated by using the feedback model 165. However, the embodiment is not limited thereto. For example, the feedback information may be acquired in a rule-based manner.

(B-15) In the embodiment described above, it may be configured that part of the functions of the feedback device 100 is released when a predetermined release condition is satisfied. For example, part or all of the function of the first learning unit 130 and the function of the second learning unit 135 may be released when the release condition is satisfied. For example, the release condition is that a management company of the feedback device 100 or a management company of the rearing system 50 is paid a fee to lift the functionality restriction of the feedback device 100. In this manner, unintentional updates of the future prediction model 160 and the feedback model 165 can be suppressed.

(B-16) The rearing system 50 may be managed by, for example, a management system that integrally manages a plurality of rearing systems including the rearing system 50. In this case, the management system may acquire rearing result data, history data such as a prediction history, a condition history, and a feedback history, and a machine learning model such as a future prediction model and a feedback model from the respective rearing systems. In this manner, the management system can execute an analysis of rearing result data or history data or execution of learning of a machine learning model by using various acquired information. Further, the management system may transmit various machine learning models thus trained to the rearing system managed by the management system.

### C. Other Modes

The present disclosure is not limited to the embodiments described above, and may be implemented in various modes without departing from the spirits of the disclosure. For example, the present disclosure may be achieved through the following modes. Appropriate replacements or combinations may be made to the technical features in the above-described embodiments which correspond to the technical features in the modes described below to solve some or all of the problems of the disclosure or to achieve some or all of the advantageous effects of the disclosure. Further, when the technical characteristics are not described as being essential in the present specification, the technical characteristics can be deleted as appropriate.

(1) According to a first mode of the present disclosure, a feedback device is provided. The feedback device includes a first acquisition unit configured to acquire first information including current information indicating a current rearing state of a cow, a second acquisition unit configured to acquire second information including at least one of future information indicating a future rearing state of the cow and an ideal condition indicating a condition ideal for rearing of the cow, and a feedback execution unit configured to execute feedback relating to the rearing to at least one of a user and a rearing device for rearing the cow. The feedback execution unit includes a generation unit configured to generate feedback information for the feedback by using the first information and the second information, and an output unit configured to output the feedback information.

According to the mode, the feedback can be executed appropriately by using the feedback information in which at least one of the current information, the future information, and the ideal condition is reflected.

(2) In the above-mentioned mode, the second information may include the future information, and the generation unit may generate the feedback information by using the first information and the future information. According to the mode, the feedback information in which the future information is reflected can be generated.

(3) In the above-mentioned mode, the second information may include the ideal condition, and the generation unit may generate the feedback information by using the first information and the ideal condition. According to the mode, the feedback information in which the ideal condition is reflected can be generated.

(4) In the above-mentioned mode, the second acquisition unit may acquire the ideal condition by using the current information to acquire the second information. According to the mode, the ideal condition corresponding to the current rearing state can be acquired. Thus, for example, a more appropriate ideal condition can be acquired as compared to a mode in which a constant ideal condition is acquired regardless of the current information.

(5) In the above-mentioned mode, the current information may include at least any one of body shape information relating to a body shape of the cow, feeding information relating to feeding of the cow, milk information relating to milk of the cow, body temperature information relating to a body temperature of the cow, movement information relating to movement of the cow, calving timing information relating to timing of calving of the cow, conception timing information relating to timing of conception of the cow, and age information relating to an age of the cow, and the ideal condition may include at least any one of a milk condition relating to the milk, a body shape condition relating to the body shape, a conception rate condition relating to a conception rate of the cow, a dry milk timing condition relating to dry milk timing of the cow, a life expectancy condition relating to life expectancy of the cow, and a disease rate condition relating to a disease rate of the cow. According to the mode, it is possible to generate the feedback information in which the body shape information, the feeding information, the milk information, the body temperature information, the motion information, the calving timing information, the conception timing information, and the age information are reflected as the current information and the milk condition, the body shape condition, the conception rate condition, the dry milk timing condition, the life expectancy condition, and the disease rate condition are reflected.

(6) In the above-mentioned mode, the current information may not include the milk information, and the ideal condition may include the milk condition. According to the mode, even when the first information does not include the milk information, the possibility of generating the feedback information that achieves ideal milk quality can be increased.

(7) In the above-mentioned mode, the current information may not include the body shape information, and the ideal condition may include the body shape condition. According to the mode, even when the first information does not include the body shape information, the possibility of generating the feedback information that achieves an ideal body shape can be increased.

(8) In the above-mentioned mode, the second information may further include the ideal condition, and the generation unit may generate the feedback information by using the first information, the future information, and the ideal condition. According to the mode, the feedback information in which the current information, the future information, and the ideal condition are reflected can be generated.

(9) In the above-mentioned mode, there may further be provided a first learning unit configured to execute learning for a future prediction model for predicting the future information, and the second acquisition unit may acquire the second information by using the future prediction model that is trained to output the future information while using the current information as an input. According to the mode, the future information can be acquired by using the future prediction model that is generated or updated by learning executing by the first learning unit, and the possibility of generating more appropriate feedback information can be increased.

(10) In the above-mentioned mode, the future information may include at least any one of information relating to a future body shape of the cow, information relating to future milk of the cow, and information relating to expected timing of calving of the cow. According to the mode, the feedback information in which the future body shape, the future milk state, and the expected calving timing are reflected can be generated.

(11) In the above-mentioned mode, there may further be provided a second learning unit configured to execute learning for a feedback model for generating the feedback information, and the generation unit may generate the feedback information by using the feedback model that is trained to output the feedback information while using the first information and the second information as inputs. According to the mode, the feedback information can be generated by using the feedback model that is generated or updated by learning executed by the second learning unit, and the possibility of generating more appropriate feedback information can be increased.

(12) In the above-mentioned mode, the feedback information may include at least any one of information for the feedback relating to feeding of the cow, information for the feedback relating to medical treatment of the cow, and information for issuing an alert to the user. According to the mode, for example, appropriate feeding, appropriate medical treatment, and appropriate treatment for improving the rearing environment can be achieved by the user or the rearing device that receives the feedback.

(13) According to a second mode of the present disclosure, a rearing system for rearing a cow is provided. The rearing system includes a rearing device for rearing the cow, a first acquisition unit configured to acquire first information including current information indicating a current rearing state of the cow, a second acquisition unit configured to acquire second information including at least one of future information indicating a future rearing state of the cow and an ideal condition indicating a condition ideal for rearing of the cow, and a feedback execution unit configured to execute feedback relating to the rearing to at least one of a user and the rearing device. The feedback execution unit includes a generation unit configured to generate feedback information for the feedback by using the first information and the second information, and an output unit configured to output the feedback information.

(14) According to a third mode of the present disclosure, a feedback method is provided. The feedback method includes acquiring first information including current information indicating a current rearing state of a cow, acquiring second information including at least one of future information indicating a future rearing state of the cow and an ideal condition indicating a condition ideal for rearing of the cow, and executing feedback relating to the rearing to at least one of a user and a rearing device for rearing the cow The feedback includes generating feedback information for the feedback by using the first information and the second information, and outputting the feedback information.

(15) According to a fourth mode of the present disclosure, a program is provided. The program causes a computer to implement a function of acquiring first information including current information indicating a current rearing state of a cow, a function of acquiring second information including at least one of future information indicating a future rearing state of the cow and an ideal condition indicating a condition ideal for rearing of the cow, and a feedback function of executing feedback relating to the rearing to at least one of a user and a rearing device for rearing the cow. The feedback function includes a generation function of generating feedback information for the feedback by using the first information and the second information, and an output function of outputting the feedback information.

In addition to each of the above-mentioned modes, the present disclosure may be implemented as a non-temporary recording medium in which the program is recorded, a program product, or the like. Note that, for example, the program product may be provided as a recording medium on which the program is recorded or as a program product that can be distributed over a network.

What is claimed is:

1. A feedback device comprising:
a first acquisition unit configured to acquire first information including current information indicating a current rearing state of a cow;
a second acquisition unit configured to acquire second information including at least one of future information indicating a future rearing state of the cow and an ideal condition indicating a condition ideal for rearing of the cow; and
a feedback execution unit configured to execute feedback relating to the rearing to at least one of a user and a rearing device for rearing the cow, wherein
the feedback execution unit includes:
a generation unit configured to generate feedback information for the feedback by using the first information and the second information; and
an output unit configured to output the feedback information.

2. A feedback device according to claim 1, wherein
the second information includes the future information, and
the generation unit generates the feedback information by using the first information and the future information.

3. A feedback device according to claim 1, wherein
the second information includes the ideal condition, and
the generation unit generates the feedback information by using the first information and the ideal condition.

4. A feedback device according to claim 3, wherein
the second acquisition unit acquires the ideal condition by using the current information to acquire the second information.

5. A feedback device according to claim 3, wherein
the current information includes at least any one of body shape information relating to a body shape of the cow, feeding information relating to feeding of the cow, milk information relating to milk of the cow, body temperature information relating to a body temperature of the cow, movement information relating to movement of the cow, calving timing information relating to timing of calving of the cow, conception timing information relating to timing of conception of the cow, and age information relating to an age of the cow, and
the ideal condition includes at least any one of a milk condition relating to the milk, a body shape condition relating to the body shape, a conception rate condition relating to a conception rate of the cow, a dry milk timing condition relating to dry milk timing of the cow, a life expectancy condition relating to life expectancy of the cow, and a disease rate condition relating to a disease rate of the cow.

6. A feedback device according to claim 5, wherein
the current information does not include the milk information, and
the ideal condition includes the milk condition.

7. A feedback device according to claim 5, wherein
the current information does not include the body shape information, and
the ideal condition includes the body shape condition.

8. A feedback device according to claim 2, wherein
the second information further includes the ideal condition, and
the generation unit generates the feedback information by using the first information, the future information, and the ideal condition.

9. A feedback device according to claim 2, comprising:
a first learning unit configured to execute learning for a future prediction model for predicting the future information, wherein
the second acquisition unit acquires the second information by using the future prediction model that is trained to output the future information while using the current information as an input.

10. A feedback device according to claim 2, wherein
the future information includes at least any one of information relating to a future body shape of the cow, information relating to future milk of the cow, and information relating to expected timing of calving of the cow.

11. A feedback device according to claim 1, comprising:
a second learning unit configured to execute learning for a feedback model for generating the feedback information, wherein
the generation unit generates the feedback information by using the feedback model that is trained to output the feedback information while using the first information and the second information as inputs.

12. A feedback device according to claim 1, wherein
the feedback information includes at least any one of information for the feedback relating to feeding of the cow, information for the feedback relating to medical treatment of the cow, and information for issuing an alert to the user.

13. A rearing system for rearing a cow, the rearing system comprising:
a rearing device for rearing the cow;
a first acquisition unit configured to acquire first information including current information indicating a current rearing state of the cow;
a second acquisition unit configured to acquire second information including at least one of future information indicating a future rearing state of the cow and an ideal condition indicating a condition ideal for rearing of the cow;
a feedback execution unit configured to execute feedback relating to the rearing to at least one of a user and the rearing device, wherein
the feedback execution unit includes:
a generation unit configured to generate feedback information for the feedback by using the first information and the second information; and
an output unit configured to output the feedback information.

14. A feedback method comprising:
acquiring first information including current information indicating a current rearing state of a cow;
acquiring second information including at least one of future information indicating a future rearing state of the cow and an ideal condition indicating a condition ideal for rearing of the cow; and
executing feedback relating to the rearing to at least one of a user and a rearing device for rearing the cow, wherein
the feedback includes:
generating feedback information for the feedback by using the first information and the second information; and
outputting the feedback information.

15. A program configured to cause a computer to implement:
a function of acquiring first information including current information indicating a current rearing state of a cow;
a function of acquiring second information including at least one of future information indicating a future rearing state of the cow and an ideal condition indicating a condition ideal for rearing of the cow; and
a feedback function of executing feedback relating to the rearing to at least one of a user and a rearing device for rearing the cow, wherein
the feedback function includes:
a generation function of generating feedback information for the feedback by using the first information and the second information; and
an output function of outputting the feedback information.
